(19) United States
(12) Patent Application Publication
(10) Pub. No.: US 2018/0203932 A1
(43) Pub. Date: Jul. 19, 2018

(54) ENHANCED INFORMATION RETRIEVAL

(71) Applicant: INTERNATIONAL BUSINESS MACHINES CORPORATION, Armonk, NY (US)

(72) Inventors: Susan M. Cox, Rochester, MN (US); Janani Janakiraman, Austin, TX (US); Nadiya Kochura, Bolton, MA (US); Fang Lu, Billerica, MA (US); Daniel Ramirez, Rochester, MN (US)

(21) Appl. No.: 15/408,658

(22) Filed: Jan. 18, 2017

(51) Int. Cl. G06F 17/30

(52) U.S. Cl. CPC G06F 17/30867

(57) ABSTRACT

Embodiments include methods, systems and computer program products for enhanced information retrieval using associated terms. In some embodiments, a request for content may be received from a user of a user device. A term association model associated with the term may be obtained. The term association model is a statistical language model. A plurality of content items may be obtained using data from the request for content. A ranking of the plurality of content items may be generated using a user-specific term association framework generated using the term association model. Presentation of the ranking of the plurality of content items to the user of the user device may be facilitated.

### BACKGROUND

The present disclosure relates to data processing, and more specifically, to methods, systems and computer program products for enhancing information retrieval with term associations.

Information retrieval systems enable users to obtain information resources relevant to an information need from a collection of information resources. Searches may be conducted using full-text or context-based indexing. An example of an information retrieval system is a search engine. A user may submit a search query indicating a user's interest in a topic. Based on the search query, the search engine may identify resources, namely websites, that are relevant to the search terms provided in the search query.

### SUMMARY

In accordance with an embodiment, a method for enhanced information retrieval is provided. The method may include receiving a request for content from a user of a user device; obtaining a term association model associated with the user, wherein the term association model is a statistical language model; obtaining a plurality of content items using data from the request for content; generating a ranking of the plurality of content items using a user-specific term association framework generated using the term association model; and facilitating presentation of the ranking of the plurality of content items to the user of the user device.

In another embodiment, a computer program product may include a non-transitory storage medium readable by a processing circuit that may store instructions for execution by the processing circuit for performing a method that may include: receiving a request for content from a user of a user device; obtaining a term association model associated with the user, wherein the term association model is a statistical language model; obtaining a plurality of content items using data from the request for content; generating a ranking of the plurality of content items using a user-specific term association framework generated using the term association model; and facilitating presentation of the ranking of the plurality of content items to the user of the user device.

In another embodiment, a system may include a processor in communication with one or more types of memory. The processor may be configured to: receive a request for content from a user of a user device; obtain a term association model associated with the user, wherein the term association model is a statistical language model; obtain a plurality of content items using data from the request for content; generate a ranking of the plurality of content items using a user-specific term association framework generated using the term association model; and facilitate presentation of the ranking of the plurality of content items to the user of the user device.

### BRIEF DESCRIPTION OF THE DRAWINGS

The forgoing and other features, and advantages of the disclosure are apparent from the following detailed description taken in conjunction with the accompanying drawings in which:

FIG. 1 is a block diagram illustrating one example of a processing system for practice of the teachings herein;

FIG. 2 is a block diagram illustrating a computing system in accordance with an exemplary embodiment;

FIG. 3 is a flow diagram of a method for generating term associations models for enhanced information retrieval in accordance with an exemplary embodiment;

FIG. 4 is a flow diagram of a method for enhanced information retrieval with term associations in accordance with an exemplary embodiment;

FIG. 5 depicts a cloud computing environment in accordance with an exemplary embodiment; and

FIG. 6 depicts abstraction model layers in accordance with an exemplary embodiment.

### DETAILED DESCRIPTION

In accordance with exemplary embodiments of the disclosure, methods, systems and computer program products for enhanced information retrieval based on term association are provided. The methods and systems described herein are directed to utilizing implicit information obtained from analyzing user inputs, such as email, texting, search queries, and the like and applying the information to search results for tailored and more relevant information delivery, in particular, by ranking the retrieved documents or search results based on the user background and relevant temporal association.

People from different cultural, historic, geographic, and/or demographic backgrounds may use different terms and/or names to identify or refer to the same entities, events, or places. For example, an older person may still refer to countries by their previous names, such as the USSR rather than Russia and other countries that previously were part of the USSR, or Yugoslavia instead of referring to the successor states, namely Bosnia and Herzegovina, Croatia, Kosovo, Macedonia, Montenegro, Servia, and Slovenia. Usage of the terms USSR and Yugoslavia may be associated with people in an identified age range, namely an older generation that learned the previous country names prior to their breakup. Terms that are frequently used and are specific to time periods may be clustered.

An example of time period clustering may be based on generational categorizations—GI generations born between 1901-1926, mature/silent generation born between 1927-1945, baby boomers born between 1945-1964, generation X born between 1965-1980, generation Y/millennials born between 1981-2000, and generation Z/boomlets born after 2001. Regional clustering may be based on terms that are frequently used by people with the different cultural backgrounds using different terms to refer to the same item. For example, “petrol” is an English term used to refer to gasoline where the American term for the same is “gas.” Other cultures may refer to the same item as “diesel” or “gasoline.” Thus, usage of a specific term may enable identification of a particular culture to associate with a user. Occupational clusters may be based on terms that are specific to a particular field. Use of specialized jargon may be indicative of a person's familiarity with a specific occupational field.

Accordingly, the systems and methods described herein may analyze terms used by people to determine relevant characteristics of a person's background or familiarity with historical events or entities. Based on the analysis, a person's domain knowledge and familiarity with particular subjects or events may be determined.

In some embodiments, the system may utilize the analysis results to provide an additional ranking of retrieved documents used in an information retrieval and knowledge discovery system. The additional ranking would provide higher scores to the information more relevant to the user's cultural, historic, regional, and/or demographic background. The system may derive knowledge of the user's familiarity with the terms that the person uses in their electronic inputs, such as emails, search queries, social media posts, instant messaging chats, blogging, and the like. Statistical correlation between terms used and the knowledge and familiarity about specific historical events, geographic regions, cultural backgrounds may be established during a system learning phase. The learned statistical correlation may then be applied during runtime for establishing the user background and applying additional scores to the retrieved information ranking.

Examples of the type of information that may be used by the system may include, but are not limited to a person's familiarity with some place names may be indicative of a person's age; a person's familiarity with old names may be indicative of the person's familiarity with historical events; a person's familiarity with cultural-specific terms may be indicative of the person's cultural background; and/or a person's familiarity with specific jargon or terms may be indicative of a person's familiarity in a specialized search space or topic.

The methods and systems described herein may generate term association models. Term association models are statistical language models generated during corpus processing using machine learning and clustering algorithms. Term association models may be used to evaluate a user's cultural, historic, geographic regional, and/or demographic background.

In some embodiments, the systems and method described herein may be integrated with a question answering (QA) or information retrieval system. During a system learning phase, term association models may be generated by processing a corpus of documents related to specific time periods, regions, demographics, historical events, and/or entities. The term association models may reflect the frequency of specific and typical terms related to selected informational clusters. The terms that are more typical and specific for a cluster may have larger weights, whereas terms that are not specific or typical to that cluster are weight lower.

During the runtime phase, the system may assign higher scores to information more relevant to the user's cultural, historic, regional, and/or demographic background. In some embodiments, the level of the user familiarity and background may be evaluated by applying one or more term association models to user electronic inputs to generate a user-specific term association framework. The user-specific term association framework may be generated by applying a term association model to emails, search queries, social media posts, and other content associated with or generated by the user. The user-specific term association framework may be used to generate scores to associate with each of a set of content items retrieved, based on a request for content from a user. In some embodiments, the more relevant to the user background and familiarity with the subject, the higher the score associated with the content item. Once a score has been generated for each of the identified content items, the content items may be ranked by their respective scores and presented to the user.

An example use case of the systems and methods described herein involve medical services. The system may identify cultural backgrounds associated with a person and the medical professional may be able to provide relevant remedies that are more likely to be effective and followed by the patient. For example, older patients from certain cultures may prefer traditional, more homeopathic remedies rather than more modern pharmaceuticals.

Another example use case involves using the system to map old names/terms to newer terms or names associated with the same region. For example, when an information retrieval system obtains geographic data or maps, the system described herein may append old names to the streets of the obtained geographic data or maps to help the user understand the obtained data better.

Another example use case is directed to building more personalized ad services. The service may provide different descriptions using specific words, phrases, and descriptions that reflect the generation values of the user. For example, if the system determines the user is a millennial, the system may personalize the advertisement using keywords that have been more effective with that particular demographic, which likely would be a different set of keywords than are associated with baby boomers.

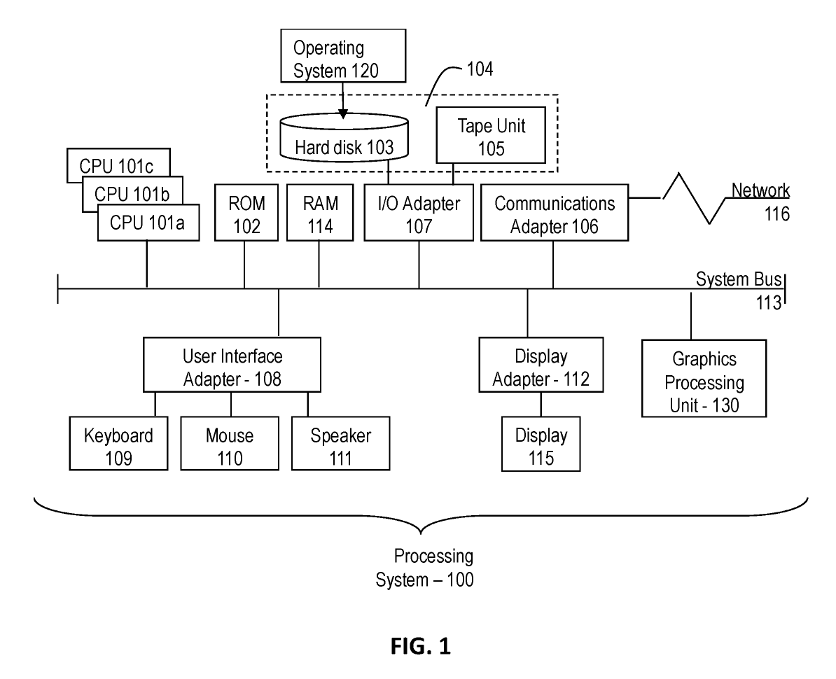

Referring to FIG. 1, there is shown an embodiment of a processing system 100 for implementing the teachings herein. In this embodiment, the system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 1 further depicts an input/output (I/O) adapter 107 and a communications adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Operating system 120 for execution on the processing system 100 may be stored in mass storage 104. A communications adapter 106 interconnects bus 113 with an outside network 116 enabling data processing system 100 to communicate with other such systems. A screen (e.g., a display monitor) 115 is connected to system bus 113 by display adapter 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnect to bus 113 via user interface adapter 108, which may include, for example, a Super I/O chip integrating multiple device adapters into a single integrated circuit.

In exemplary embodiments, the processing system 100 includes a graphics-processing unit 130. Graphics processing unit 130 is a specialized electronic circuit designed to manipulate and alter memory to accelerate the creation of images in a frame buffer intended for output to a display. In general, graphics-processing unit 130 is very efficient at manipulating computer graphics and image processing, and has a highly parallel structure that makes it more effective than general-purpose CPUs for algorithms where processing of large blocks of data is done in parallel.

Thus, as configured in FIG. 1, the system 100 includes processing capability in the form of processors 101, storage capability including system memory 114 and mass storage 104, input means such as keyboard 109 and mouse 110, and output capability including speaker 111 and display 115. In one embodiment, a portion of system memory 114 and mass storage 104 collectively store an operating system such as the AIX® operating system from IBM Corporation to coordinate the functions of the various components shown in FIG. 1.

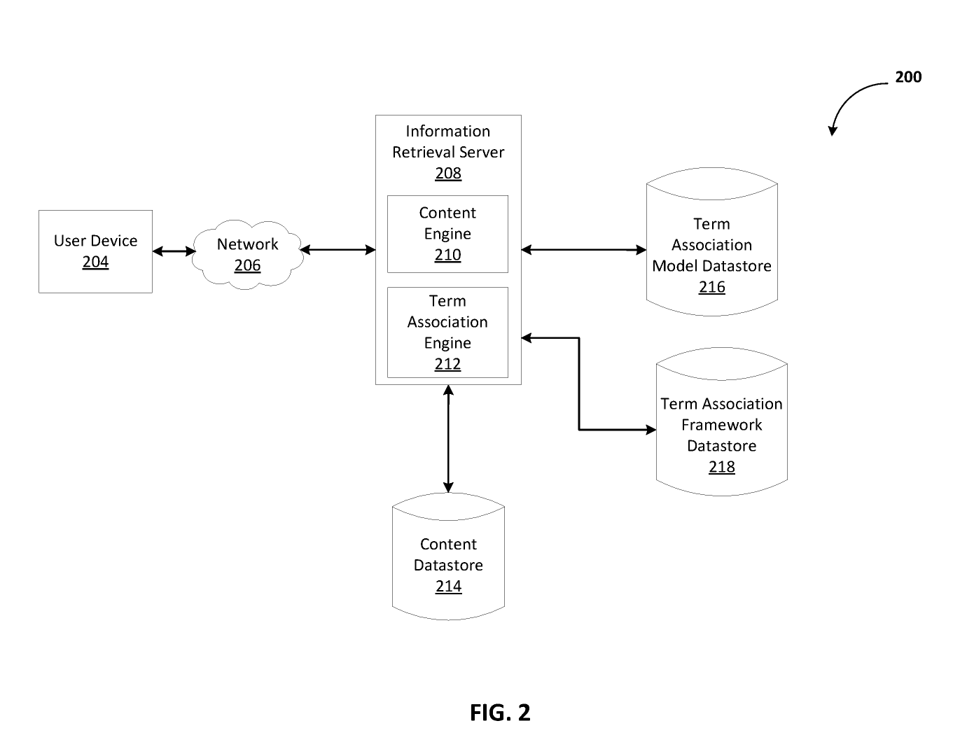

Referring now to FIG. 2, a computing system 200 in accordance with an embodiment is illustrated. As illustrated, the computing system 200 may include, but is not limited to, a user device 204, an information retrieval server 208, a content datastore 214, a term association model datastore 216, and/or a term association framework datastore 218 connected via one or more networks 206. Although depicted as a client-server architecture, in some embodiments, the methods and systems described herein may be implemented using a cloud service architecture, where the user device 204 and the information retrieval server 208 communicate with functionality provided in a cloud computing environment.

The user device 204 may be any type of computing device, such as a computer, laptop, tablet, smartphone, wearable computing device, server, etc. The user device 204 may be capable of communicating with other devices over one or more networks 206. The user device 204 may be able to execute applications for email, social media, searching datastores, or any other type of activity associated with a network-enabled computing device.

The network(s) 206 may include, but are not limited to, any one or a combination of different types of suitable communications networks such as, for example, cable networks, public networks (e.g., the Internet), private networks, wireless networks, cellular networks, or any other suitable private and/or public networks. Further, the network(s) 206 may have any suitable communication range associated therewith and may include, for example, global networks (e.g., the Internet), metropolitan area networks (MANs), wide area networks (WANs), local area networks (LANs), or personal area networks (PANs). In addition, the network(s) 206 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof.

In some embodiments, the information retrieval (IR) server 208 may be any type of computing device with network access, such as a computer, laptop, server, tablet, smartphone, wearable computing devices, or the like. The content engine 210 may include computer-readable instructions that in response to execution by the processor(s) 101, cause operations to be performed including receiving a request from the user device 204. The content engine 210 may process and/or parse the request. The content engine 210 may obtain a user identifier or a user device identifier from the request. Additionally, the content engine 210 may obtain a request for content. In some embodiments, the request for content may be a query and the content engine 210 may obtain one or more parameters to use when obtaining content. In some embodiments, the content engine 210 may transmit the user identifier or the user device identifier from the request to the term association engine 212.

In some embodiments, the content engine 210 may use the information from the request, such as the one or more parameters or search query to obtain a set of content items from one or more content datastores 214. Examples of content items may include electronic documents (e.g., PDF, word processing documents, presentations, websites, etc.). The content engine 210 may obtain the set of content items from the one or more content datastores and may make a set of objects available to the term association engine 212.

The term association engine 212 may include computer-readable instructions that in response to execution by the processor(s) 101, cause operations to be performed including corpus processing using machine learning techniques and clustering algorithms to generate term association models based on specific time periods, geographic regions, demographics, historical events, and/or entities. Term association models are statistical language models that are used to evaluate the cultural, historical, regional, and/or demographic background of a user. Upon generating a terms association model, the term association engine 212 may transmit the model to a term association model datastore 216.

In some embodiments, the term association engine 212 may receive an identification of a user or user device 204 from the content engine 210. The term association engine 212 facilitate generation of a user-specific term association framework by processing electronic inputs or content associated with the user. Examples of electronic inputs or content associated with the user may include, but are not limited to, emails, social media posts, electronic documents, search queries, instant messaging chats, text messages, blog postings, websites, or the like. The term association engine 212 may apply one or more term association models (e.g., obtained from the term association model datastore 216) to the electronic inputs or content associated with the user to generate a user-specific term association framework. The user-specific term association framework may reflect a level of familiarity and background to certain topics, subjects, etc. that are specific to the user. The term association engine 212 may transmit the user-specific term association framework to a term association framework datastore 218. In some embodiments, the term association framework datastore 218 may be a remote datastore. In some embodiments, the term association framework datastore 218 may be stored on the user device 204 associated with the user.

In some embodiments, the term association engine 212 may receive a user identifier or user device identifier in response to receiving a request for content from the user device 204. The term association engine 212 may use the user identifier or the user device identifier to retrieve a user-specific term association framework. In some embodiments, the term association engine 212 may retrieve the user-specific term association framework from one or more term association framework datastores 218. The term association engine 212 may also receive a set of content or a list of a set of content obtained in response to the request for content. The term association engine 212 may apply the user-specific term association framework to the set of content and generate a score associated with each of the content items of the set of content. In some embodiments, the score may indicate a level of user familiarity and background associated with the content item. In some embodiments, the term association engine 212 may process the content item using the user-specific term association framework to generate a score. In some embodiments, the term association engine 212 may process metadata associated with the content item using the user-specific term association framework to generate the score. In some embodiments, the metadata may have been previously generated by the term association engine 212 during a system learning stage. The metadata may indicate the type of content or terms associated with the content of the content item. In one example embodiment, the more relevant to the user background and familiarity with the subject of a content item, the higher the score associated with the content item. The term association engine 212 may order the content items based on their generated scores and may facilitate the presentation of the content items to the user of the user device 204.

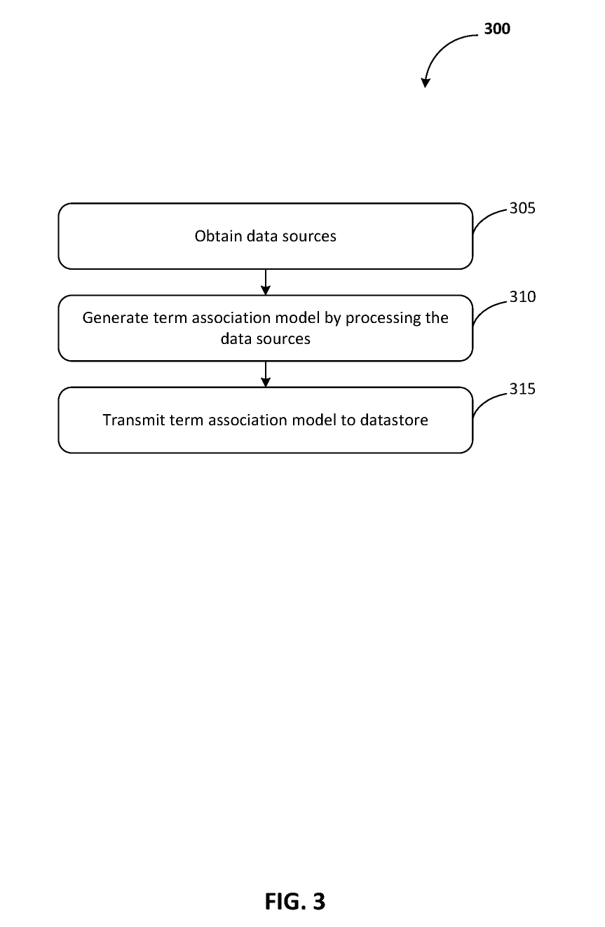

Now referring to FIG. 3, a flow diagram of a method 300 for generating term associations models for enhanced information retrieval in accordance with an exemplary embodiment is depicted. At block 305, data sources may be obtained. In some embodiments, data sources may be identified by one or more users or administrators of the system. In some embodiments, the data sources may be texts, documents, or other corpus or collection of written texts. Examples of corpus may include newspapers, books, letters, websites, speeches, or the like. Data sources may be identified by users by location (e.g., hyperlink to the corpus). In some embodiments, data sources may be provided in electronic form (e.g., electronic documents or images). Data sources may be related to specific time periods, regions, demographics, historical events, and/or entities. An example of a data source for a specific time period and geographic region may be a Bostonian newspaper during the Great Depression.

At block 310, the data sources may be processed to generate a term association model. In some embodiments, the corpus of content may be processed using machine learning techniques and clustering algorithms. The processing of data sources may occur during a learning stage, where data sources are identified and processed to generate a term association model. The machine learning techniques and clustering algorithms may be applied to the data sources to identify clusters of terms associated with an identified common characteristic, such as a specific period of time, geographic region, demographic characteristic, historical event, and/or entities. The term association model may reflect the frequency of the specific and typical terms related to a selected information cluster. In some embodiments, terms that are more typical and specific to a cluster may have larger weights in the cluster, whereas terms that are not specific or typical to that cluster are weighted lower.

At block 315, the term association model may be transmitted to a datastore. In some embodiments, the term association model may be transmitted to a term association model datastore 216. The term association model datastore 216 may be a remote datastore. In some embodiments, the term association model datastore 216 may be available via a cloud computing service.

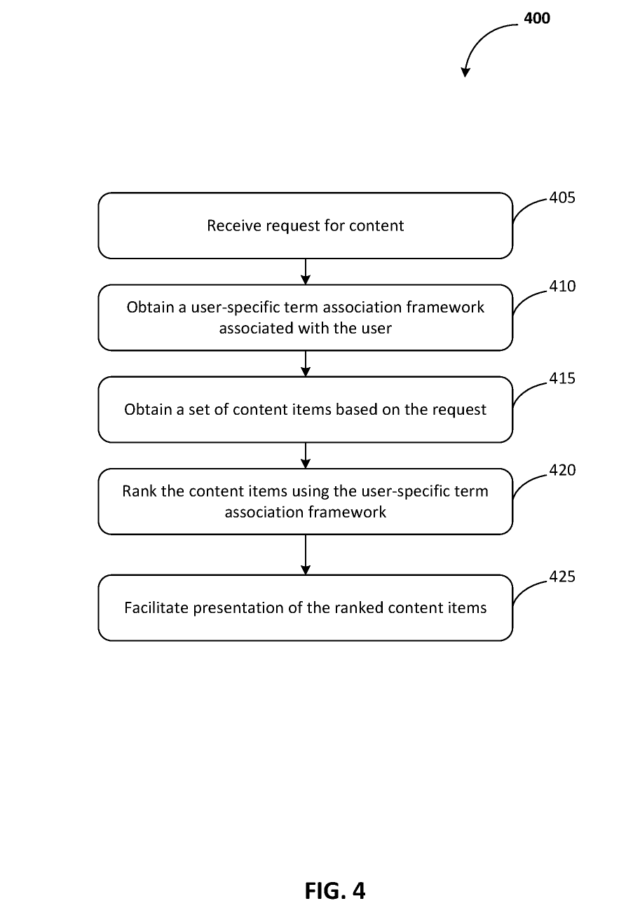

Now referring to FIG. 4, a flow diagram of a method 400 for enhanced information retrieval with term associations in accordance with an exemplary embodiment is depicted. At block 405, a request for content may be received. In some embodiments, a user of a user device 204 may generate a request for content. The request for content may include a query. The information retrieval server 208 may receive the request from the user device 204 over a network 206. The content engine 210 may parse the request to identify the user as well as one or more parameters associated with the request for content. The content engine 210 may transmit to the term association engine 212 data associated with the user, such as a user identifier or a user device identifier.

At block 410, a user-specific term association framework associated with the user may be obtained. The term association engine 212 may receive data associated with the user from the content engine 210. The term association engine 212 may obtain a user-specific term association framework using the data associated with the user. In some embodiments, the user-specific term association framework may be obtained from a term association framework datastore 218. The term association framework datastore 218 may reside in a remote datastore. In some embodiments, the term association framework datastore 218 may reside on a storage component of the user device 204.

In some embodiments, the user-specific term association framework may be generated by applying one or more term association models to content associated with the user. Examples of content associated with the user may include, but are not limited to emails, search queries, electronic chats, social media posts, or the like.

At block 415, a set of content items may be obtained based on the request. In some embodiments, the content engine 210 may obtain a set of content items based on the one or more parameters associated with the request for content. Content items may be obtained from one or more content datastores 214. In some embodiments, the content engine 210 may obtain content items in parallel to the term association engine 212 identifying and obtaining a user-specific term association framework. In some embodiments, the content engine 210 and the term association engine 212 may execute asynchronously to obtain their respective data.

At block 420, the content items may be ranked using the user-specific term association framework. In some embodiments, the term association engine may generate a score for each of the content items obtained by the content engine 210 using the user-specific term association framework. For example, the term association engine 212 may process the content item to determine characteristics of the content item based on a specific period of time, geographic region, demographic characteristic, historical event, and/or entities. In some embodiments, the term association engine 212 may process metadata associated with the content item to generate a score for the content item. In some embodiments, the term association engine 212 may have previously processed the content item and generated metadata to associate with the content item, which would later be used to assess the content item and generate a score to associate with the content item for a user based on the user-specific term association framework. In some embodiments, the term association engine 212 may order the content items based the score generated for each of the identified content items.

At block 425, presentation of the ranked content items may be facilitated. In some embodiments, a list of the ranked content items may be transmitted to the user device 204 for presentation to the user. In some embodiments, the list of ranked content items may be stored on a remote server or datastore and a link to the list may be transmitted to the user device 204 for presentation to the user.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

### Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

### Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

### Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

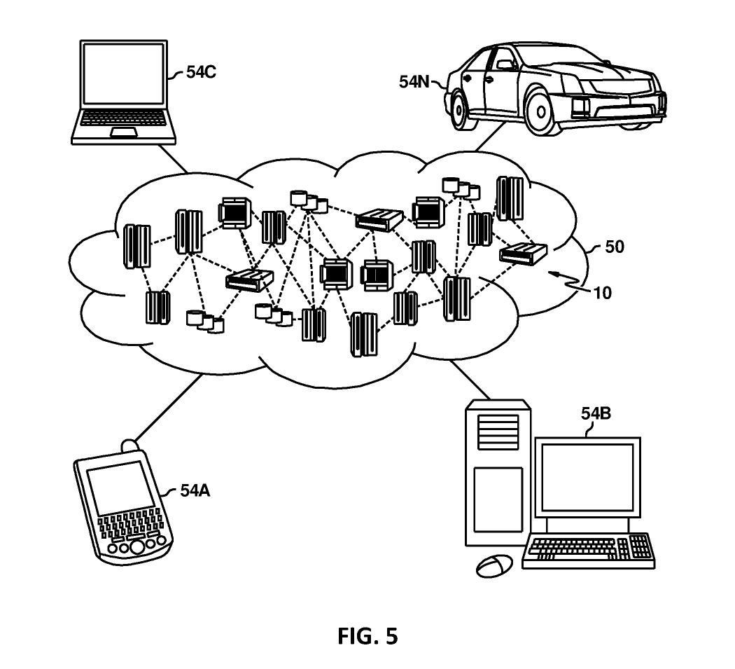

Referring now to FIG. 5, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

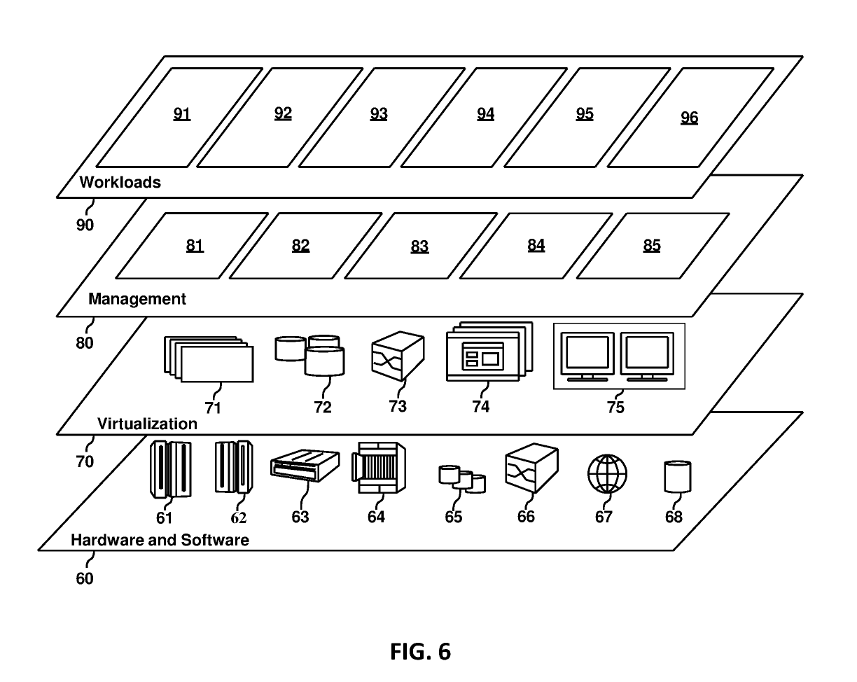

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and enhanced information retrieval using term association 96.

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for enhanced information retrieval, the method comprising:
receiving a request for content from a user of a user device;
obtaining a term association model associated with the user, wherein the term association model is a statistical language model;
obtaining a plurality of content items using data from the request for content;
generating a ranking of the plurality of content items using a user-specific term association framework generated using the term association model; and
facilitating presentation of the ranking of the plurality of content items to the user of the user device.

2. The computer-implemented method of claim 1, further comprising:
generating the term association model by processing corpus of content using machine learning and clustering algorithms.

3. The computer-implemented method of claim 2, wherein the term association model comprises clusters of data related to time periods, geographic regions, demographics, historical events, or entities.

4. The computer-implemented method of claim 1, further comprising:
generating the user-specific term association framework by applying the term association model to content associated with the user.

5. The computer-implemented method of claim 4, wherein the content associated with the user comprises at least one of emails, search queries, or social media posts.

6. The computer-implemented method of claim 1, wherein the user-specific term association framework is stored on the user device.

7. The computer-implemented method of claim 1, wherein generating the ranking of the plurality of content items further comprises:
generating a score for each of the plurality of content items using the user-specific term association framework; and
ordering the plurality of content items based the score for each of the plurality of content items.

8. A computer program product comprising a non-transitory storage medium readable by a processing circuit and storing instructions for execution by the processing circuit for performing a method comprising:
receiving a request for content from a user of a user device;
obtaining a term association model associated with the user, wherein the term association model is a statistical language model;
obtaining a plurality of content items using data from the request for content;
generating a ranking of the plurality of content items using a user-specific term association framework generated using the term association model; and
facilitating presentation of the ranking of the plurality of content items to the user of the user device.

9. The computer program product of claim 8, wherein the method further comprises:
generating the term association model by processing corpus of content using machine learning and clustering algorithms.

10. The computer program product of claim 8, wherein the term association model comprises clusters of data related to time periods, geographic regions, demographics, historical events, or entities.

11. The computer program product of claim 8, wherein the method further comprises:
generating the user-specific term association framework by applying the term association model to content associated with the user.

12. The computer program product of claim 11, wherein the content associated with the user comprises at least one of emails, search queries, or social media posts.

13. The computer program product of claim 8, wherein the user-specific term association framework is stored on the user device.

14. The computer program product of claim 8, wherein generating the ranking of the plurality of content items further comprises:
generating a score for each of the plurality of content items using the user-specific term association framework; and
ordering the plurality of content items based the score for each of the plurality of content items.

15. A system, comprising:
a processor in communication with one or more types of memory, the processor configured to:
receive a request for content from a user of a user device;
obtain a term association model associated with the user, wherein the term
association model is a statistical language model;
obtain a plurality of content items using data from the request for content;
generate a ranking of the plurality of content items using a user-specific term association framework generated using the term association model; and
facilitate presentation of the ranking of the plurality of content items to the user of the user device.

16. The system of claim 15, wherein the processor is further configured to:
generate the term association model by processing corpus of content using machine learning and clustering algorithms.

17. The system of claim 15, wherein the term association model comprises clusters of data related to time periods, geographic regions, demographics, historical events, or entities.

18. The system of claim 15, wherein the processor is further configured to:
generate the user-specific term association framework by applying the term association model to content associated with the user.

19. The system of claim 18, wherein the content associated with the user comprises at least one of emails, search queries, or social media posts.

20. The system of claim 15, wherein the user-specific term association framework is stored on the user device.
